(19) United States
(12) Patent Application Publication
(10) Pub. No.: US 2004/0027382 A1
(43) Pub. Date: Feb. 12, 2004

(54) Method for a software application for triggering an action relating to a data object, and data processing device having the software application

(76) Inventors: Marion Kuehn, Nuernberg (DE); Marc Rose, Erlangen (DE); Juergen Wohlrab, Forchheim (DE)

Correspondence Address: HARNESS, DICKEY & PIERCE, P.L.C., P.O.BOX 8910, RESTON, VA, 20195, US

(21) Appl. No.: 10/417,202

(22) Filed: Apr. 17, 2003

(30) Foreign Application Priority Data
Apr. 17, 2002 (DE) 10217063.0

(51) Int. Cl. G09G 5/00

(52) U.S. Cl. 345/769

(57) ABSTRACT

A method is for triggering an action relating to a data object, which contains data as a result of the performance of a drag&drop operation in a software application. A data processing device includes the software application. In the course of the drag&drop operation, upon initiation of the loading of a selected source data object containing data into the software application, the compatibility of the data in the source data object and at least one of the data supported by the software application and data in at least one data object already existing in the software application can be taken as a basis for triggering an action relating to at least one of the source data object and to the existing data object.

The present application hereby claims priority under 35 U.S.C. §119 on German patent application number DE 10217063.0 filed Apr. 17, 2002, the entire contents of which are hereby incorporated herein by reference.

### FIELD OF THE INVENTION

The invention generally relates to a method for triggering an action relating to a data object which contains data as a result of the performance of a drag&drop operation in a software application. The invention also generally relates to a data processing device having a software application, in which an action relating to a data object which contains data can be triggered as a result of the performance of a drag&drop operation in the software application.

### BACKGROUND OF THE INVENTION

In software technology, a user can use a drag&drop operation to load a data object into a software application. In this context, a drag&drop operation is understood to relate to cutting a data object, for example a file or a document, from a source window and inserting the data object in a destination window, or moving or copying a data object from a source window to a destination window. Accordingly, a drag&drop operation performed on a data object generally triggers one loading operation for the data object into a destination window in a software application. If a user wishes to trigger a further action relating to the data object, this needs to be triggered separately following loading using a drag&drop operation.

### SUMMARY OF THE INVENTION

An embodiment of the invention is based on an object of specifying a method and a data processing device in which a drag&drop operation provides the user with an extended functionality.

An embodiment of the invention may achieve an object by a method and/or a data processing device. In line with an embodiment of the invention, in the course of performance of a drag&drop operation in a software application on a selected source data object containing data, the compatibility of the data in the source data object and the data supported by the software application or data in at least one data object already existing in the software application is taken as a basis for triggering an action relating to the source data object and/or the existing data object. Accordingly, the compatibility of data in a source data object and data supported by the software application or data in a data object existing in the software application is taken as a basis for deciding how to deal with the source data object and/or with the data object existing in the software application, that is to say, by way of example, whether the source data object needs to be loaded into the software application at all. In this way, performance of the drag&drop operation can involve direct triggering of a particular action relating to the source data object and/or to an existing data object, which previously was not possible until a source data object had been loaded into a software application by way of a drag&drop operation.

In one variant of an embodiment of the invention, in the course of performance of the drag&drop operation on a source data object, the source data object is loaded into the software application only if the data in the source data object and the data in a data object existing in the software application are compatible with one another. This makes it possible to ensure, by way of example, that only data objects containing data of a particular type can be loaded into the software application.

In another variant of an embodiment of the invention, in the course of performance of the drag&drop operation on a source data object, the source data object can replace a data object existing in the software application if the data in the source data object and the data in the data object which exists in the software application and is to be replaced are compatible with one another. This variant of an embodiment of the invention thus allows the loading of a source data object into the software application to be linked to the unloading of a data object from the software application.

In another variant of an embodiment of the invention, in the course of performance of a drag&drop operation on a source data object, loading the source data object into the software application involves all the data objects which exist in the software application being unloaded from the software application if the data in the source data object and the data in the existing data object(s) are not compatible with one another. In the case of this variant too, loading of a source data object into the software application is linked to unloading of one or more data objects from the software application, which ensures that the software application only ever contains data of one type.

If the software application has a subarea which can contain only data objects of the same type, variants of embodiments of the invention provide for the source data object to be loaded into the subarea of the software application, or for the source data object to be able to replace a data object existing in the subarea of the software application, only if the data in the source data object and the data in the data object existing in the subarea are compatible with one another. In another embodiment of the invention, loading of the source data object into the subarea involves all the data objects which exist in the subarea of the software application being unloaded if the data in the source data object and the data in the data object(s) existing in the subarea are not compatible with one another.

In another variant of an embodiment of the invention, the action is triggered in the course of performance of the drag&drop operation only if the latter is confirmed by a user. Preferably, the action to be performed is displayed to a user, e.g. using a dialog window, so that the user can also reject performance of the action or, if alternative actions are possible, can choose one of the alternatives. If a drag&drop operation is performed on a source data object which contains data of the same type as data objects already existing in the software application, it is possible to display to the user, by way of example, the alternatives “Add the source data object to the already existing data objects” or “Replace one of the data objects already existing in the software application”.

In another embodiment of the invention, the data objects contain medical measured data.

### BRIEF DESCRIPTION OF THE DRAWINGS

Exemplary embodiments of the invention are illustrated in the appended schematic figures, in which:

FIG. 1 shows the loading of a source data object containing data of a type A into a software application,

FIG. 2 shows the replacement of a data object containing data of a type A with a source data object containing data of a type A in a software application,

FIG. 3 shows the loading of a source data object containing data of a type B into a software application and the unloading of data objects containing data of a type A from the software application,

FIG. 4 shows the loading of a source data object containing data of a type A into a subarea of the software application,

FIG. 5 shows the replacement of a data object containing data of a type A with a source data object containing data of a type A in a subarea of a software application, and

FIG. 6 shows the loading of a source data object containing data of a type B into a subarea of a software application and the unloading of data objects containing data of a type A from the subarea of the software application.

### DETAILED DESCRIPTION OF THE PREFERRED EMBODIMENTS

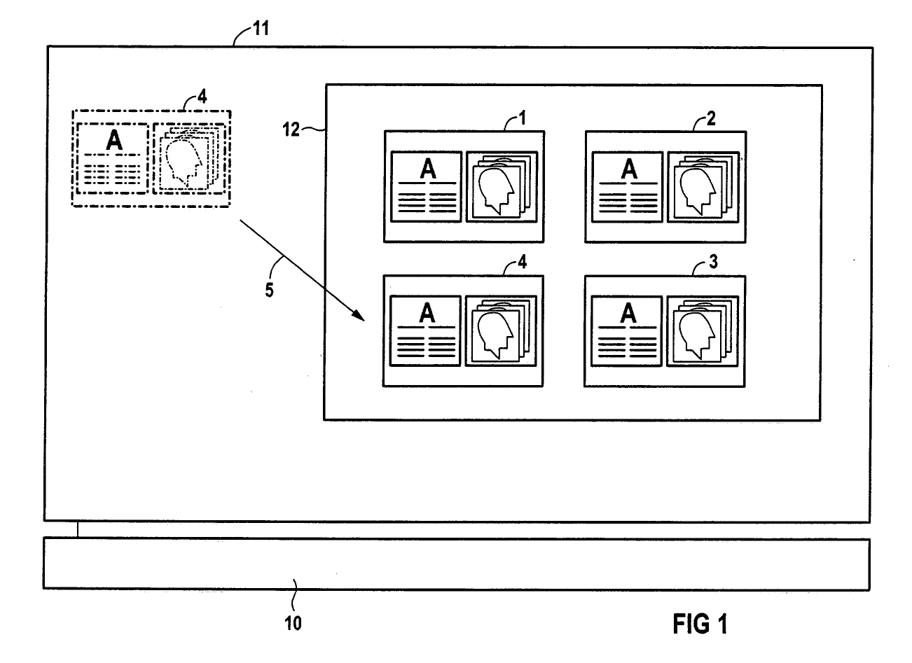

FIG. 1 schematically shows a data processing device which, in the case of the present exemplary embodiment, is a commercially available computer 10 for a medical instrument (not shown in more detail). The computer 10 is performing a software application, for example a computer program. In this case, screen masks in the software application can be displayed in a manner which is known per se on a visual display unit 11 connected to the computer 10. In the case of the present exemplary embodiment, a screen mask 12 in the software application, which contains three data objects 1 to 3 containing data of a type A, is displayed on the visual display unit 11. The data objects 1 to 3 contain medical measured data, for example image data.

A source data object 4, which is likewise displayed on the visual display unit 11 and likewise contains medical measured data, needs to be loaded into the software application by performing a drag&drop operation. In the case of the present exemplary embodiment, the drag&drop operation is performed by virtue of a cursor being moved (in a manner which is not shown) onto the source data object 4 using an input medium connected to the computer 10, for example a computer mouse, the object being selected by clicking a mouse button and being moved into the software application, generally by holding down the mouse button, with release of the mouse button initiating an operation which loads the source data object 4 into the software application. The performance of the drag&drop operation on the source data object 4 is illustrated in FIG. 1 by the arrow 5. In the case of the exemplary embodiment shown in FIG. 1, however, the drag&drop operation is in a form such that the source data object 4 is loaded into the software application only if the data in the source data object 4 and the data in the data objects 1 to 3 existing in the software application are of the same type.

Since, in the case of the present exemplary embodiment, the data objects 1 to 3 existing in the software application and the source data object 4 contain data of type A, initiation of the loading operation is followed by the source data object 4 actually being loaded into the software application. If the source data object were to contain data of a type other than type A, the source data object would not be loaded into the software application, despite performance of the drag&drop operation and hence initiation of loading. Instead, the user performing the drag&drop operation would receive corresponding advice that the data in the source data object are of a type other than the data in the data objects 1 to 3 stored in the software application, which is why it is not possible to load the source data object into the software application.

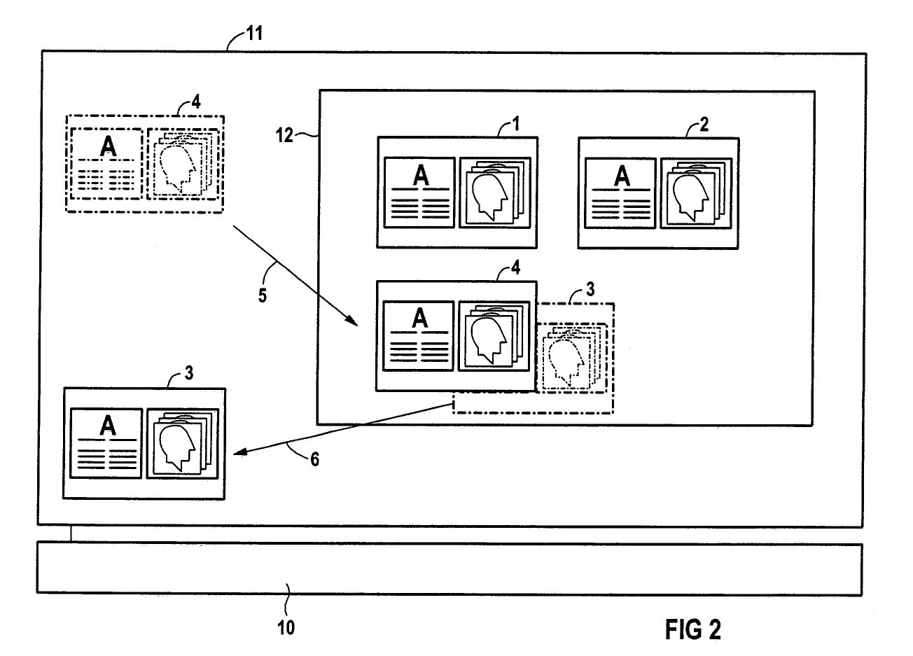

FIG. 2 shows another embodiment of the invention in which the drag&drop operation is in a form such that a data object existing in the software application can be replaced with the source data object 4 if the data in the source data object 4 are of the same type as the data in the data object existing in the software application. Since, in the case of the exemplary embodiment shown in FIG. 2, the data in the data objects 1 to 3 are of the same type A as the data in the source data object 4, the drag&drop operation can accordingly be applied to the source data object 4 successfully. As described above, this involves using a computer mouse to move a cursor onto the source data object 4 and clicking and holding down a mouse button to move the cursor onto a data object which is to be replaced, with release of the mouse button firstly initiating the operation which loads the source data object 4 into the software application, and also performing it on account of the identical type, and secondly unloading the data object 3 to be replaced from the software application. The drag&drop operation is again identified by an arrow 5 in FIG. 2, with the operation which unloads the data object 3 from the software application being illustrated by an arrow 6.

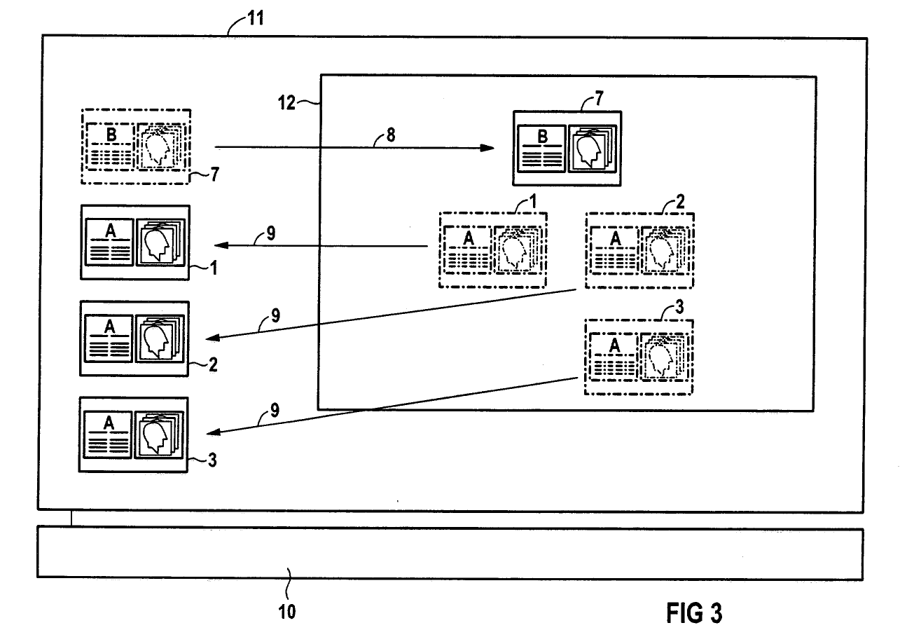

In the embodiment of the invention which is illustrated in FIG. 3, the drag&drop operation is in a form such that performing the drag&drop operation and accordingly initiating loading of a source data object 7 containing data of type B, which are likewise medical measured data, into the software application involve all the data objects which exist in the software application being unloaded from the software application if the data in the source data object 7 and the data in the data objects existing in the software application are not of the same type. Since, in the case of the present exemplary embodiment, the source data object 7 contains data of type B but the data objects 1 to 3 existing in the software application contain data of type A, performance of a drag&drop operation on the source data objects 7 by moving the latter, as in the exemplary embodiments described above, into the software application using a computer mouse firstly involves the source data object 7 being loaded into the software application as a result of the mouse button being released and secondly involves the data objects 1 to 3 being unloaded from the software application. The loading operation for the source data object 7 as a result of the drag&drop operation on the source data object 7 is illustrated by an arrow 8, and the unloading operations for the data objects 1 to 3 are illustrated by arrows 9.

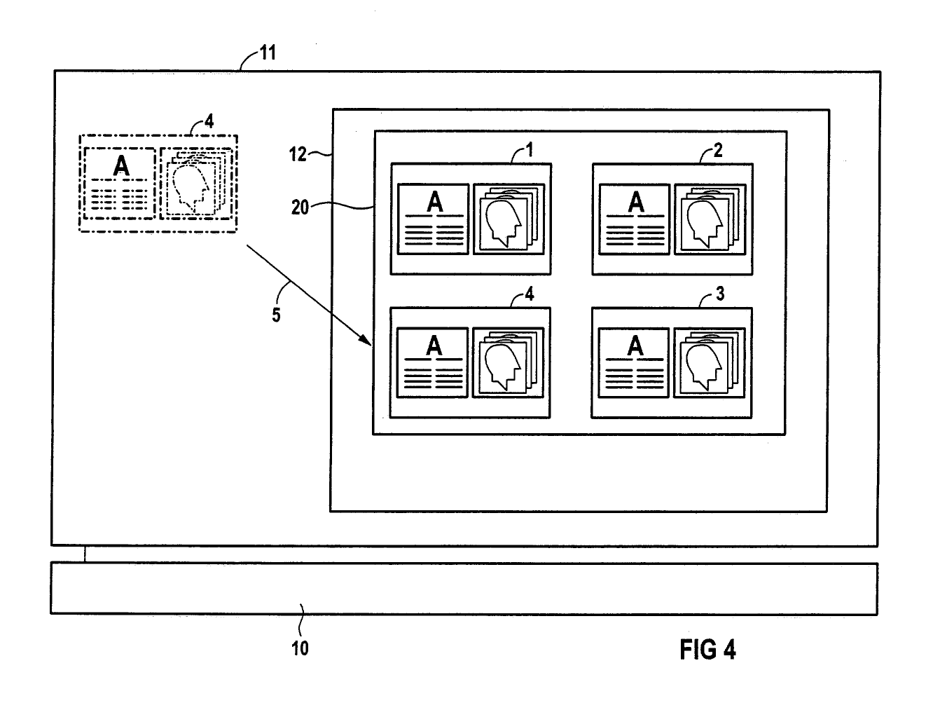

FIG. 4 illustrates an exemplary embodiment which differs from the exemplary embodiment illustrated in FIG. 1 only in that the software application has at least one subarea which can contain only data objects containing data of the same type. In the case of the present exemplary embodiment, the subarea 20 contains the data objects 1 to 3, which contain data of type A. The drag&drop operation to be performed on the source data object 4 is in a form such that the source data object 4 is loaded into the subarea 20 only if the data in the source data object 4 are of the same type as the data in the data objects 1 to 3, which already exist in the subarea 20 of the software application. Since, in the case of the present exemplary embodiment, the data in the source data object 4 are of type A, as are the data in the data objects 1 to 3 which are already present in the subarea 20 of the software application, initiation of the loading of the source data object 4 is accordingly followed by the source data object 4 actually being loaded into the subarea 20 of the software application.

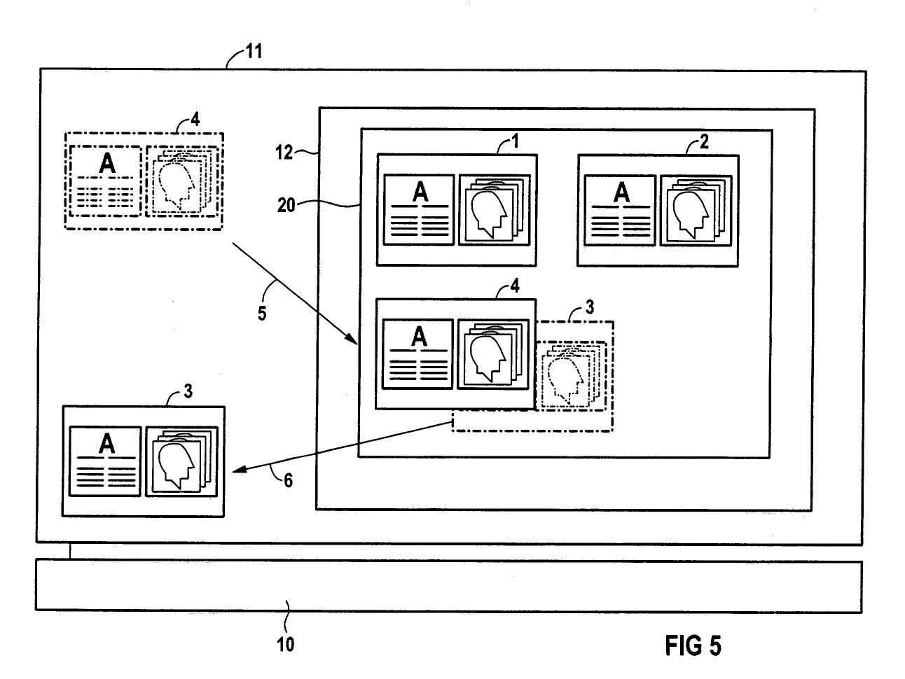

The exemplary embodiment illustrated in FIG. 5 likewise differs from the exemplary embodiment illustrated in FIG. 2 only to the extent that the software application has a subarea 20 which can contain only data objects whose data are of the same type. In the case of the present exemplary embodiment, the subarea 20 contains the data objects 1 to 3, which contain data of type A. Since the source data object 4 also contains data of type A, performance of the drag&drop operation on the source data object 4, which involves the source data object 4 being moved onto the data object 3, prompts the source data object 4 to replace the data object 3 in the subarea 20. The source data object 4 is thus loaded into the subarea 20 of the software application, and the data object 3 is unloaded from the subarea 20 of the software application.

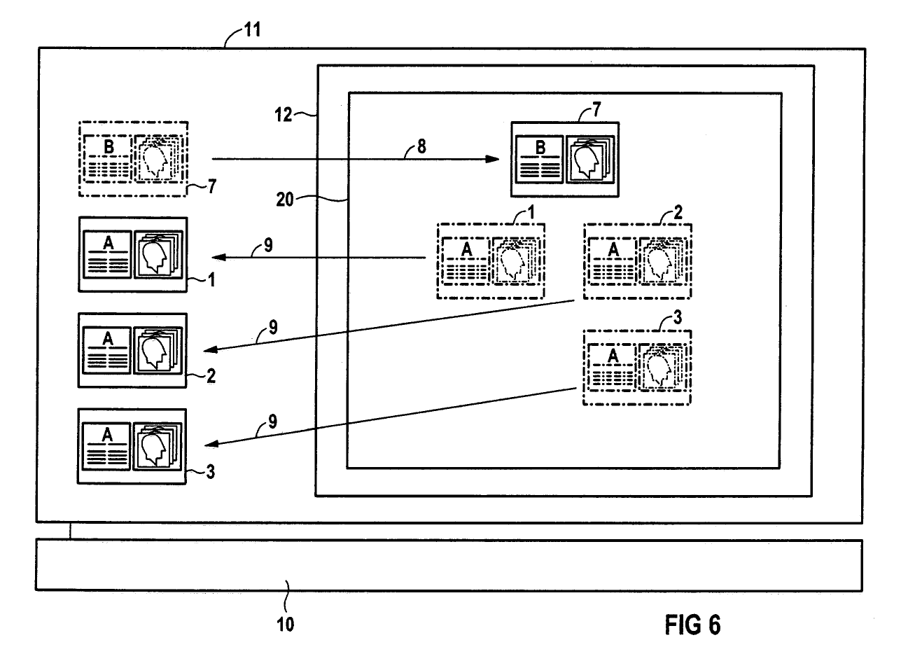

The exemplary embodiment illustrated in FIG. 6 differs from the exemplary embodiment illustrated in FIG. 3 in that the software application has a subarea 20 which ought to contain only data objects containing data of the same type. In the case of the present exemplary embodiment, the subarea 20 contains the data objects 1 to 3, which contain data of type A. A drag&drop operation needs to be performed on the source data object 7, with the source data object 7 needing to be loaded into the subarea 20 of the software application 1. In the case of the exemplary embodiment shown in FIG. 6, the drag&drop operation is now in a form such that initiating loading of the source data object 7 into the subarea 20 of the software application by moving the source data object 7 onto the subarea 20 using a mouse involves all the data objects which exist in the subarea 20 of the software application being unloaded if the data in the source data object 7 and the data in the data objects 1 to 3 existing in the subarea 20 are not of the same type. Since this is so in the present case, initiation of loading of the source data object 7 into the subarea 20 of the software application involves the data objects 1 to 3 being unloaded from the subarea 20 of the software application, which is illustrated by the arrows 9.

The outlined forms of a drag&drop operation can thus ensure that, in the case of the present exemplary embodiments, directories or subareas of the software application performed on the computer 10 for the medical instrument contain only medical measured data of one particular type.

Whether a drag&drop operation is actually performed on a source data object, as illustrated with reference to FIGS. 1 to 6, can additionally be made dependent on confirmation from the user who is performing the drag&drop operation. In this case, whenever a user moves a source data object into a software application or a subarea of the software application in the course of a drag&drop operation (not shown), a window is opened in which the consequence of his action is explained to the user again and the user is asked whether he would still like to perform the action. In the case of the exemplary embodiment shown in FIG. 3, this would mean, by way of example, that, before the data objects 1 to 3 are unloaded from the software application, the user is asked whether he actually wishes to load the source data object 7 into the software application if this means that the data objects 1 to 3 are unloaded from the software application. The operation is not performed finally until the user confirms his intentions.

A drag&drop operation in accordance with the invention can additionally also be in a form such that it features a plurality of or all of the functions explained with reference to FIGS. 1 to 6. In this case, it is advantageous to display the action to be performed to a user of the drag&drop operation, e.g. using a dialog window. This is particularly useful when alternative actions are possible. If a drag&drop operation is performed on a source data object which contains data of the same type as data objects already existing in the software application, it is possible to display to the user, by way of example, the alternatives “Add the source data object to the already existing data objects” or “Replace one of the data objects already existing in the software application”. This gives the user additional control options. The respectively selected action is not performed until it has been confirmed by the user.

In the case of the exemplary embodiments illustrated, it has always been crucial to the triggering of an action, in the form of loading or not loading the source data object into the software application or unloading data objects existing in the software application from the software application, whether or not the data in the source data object and in the existing data object(s) were of the same type. This does not necessarily have to be the case, however. Instead, the only crucial point for triggering the respective action can also be whether the data in the source data object and in the existing data object(s) are compatible or not compatible with one another.

In addition, the data in the data objects 1 to 4 and 7 do not necessarily have to be medical measured data.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for triggering an action relating to an object which contains data as a result of the performance of a drag&drop operation in a software application, comprising:
using, in the course of the operation, upon initiation of the loading of a selected source data object containing data into the software application, compatibility of the data in the source data object and at least one of the data supported by the software application and data in at least one data object already existing in the software application, as a basis for triggering an action relating to at least one of the source data object and to the existing data object.

2. The method as claimed in claim 1, wherein the source data object is loaded into the software application only if the data in the source data object and the data in a data object existing in the software application are compatible with one another.

3. The method as claimed in claim 1, wherein the source data object replaces a data object existing in the software application if the data in the source data object and the data in the data object, which exists in the software application and is to be replaced, are compatible with one another.

4. The method as claimed in claim 1, wherein loading the source data object into the software application involves all the data objects (which exist in the software application being unloaded from the software application if the data in the source data object and the data in the existing data object(s) are not compatible with one another.

5. The method as claimed in claim 1, wherein the software application includes a subarea, containing only data objects containing data which are compatible with one another, the source data object being loaded into the subarea of the software application only if the data in the source data object and the data in a data object existing in the subarea are compatible with one another.

6. The method as claimed in claim 1, wherein the software application includes a subarea, containing only data objects containing data which are compatible with one another, the source data object, upon being loaded into the subarea, being able to replace a data object existing in the subarea of the software application if the data in the source data object and the data in the data object existing in the subarea are compatible with one another.

7. The method as claimed in claim 1, wherein the software application includes a subarea, containing only data objects containing data which are compatible with one another, the loading of the source data object into the subarea involving all the data objects which exist in the subarea of the software application being unloaded if the data in the source data object and the data in the data object(s) existing in the subarea are not compatible with one another.

8. The method as claimed in claim 1, wherein triggering of the action needs to be confirmed.

9. The method as claimed in claim 1, wherein the data objects contain medical measured data.

10. A data processing device, comprising:
a software application, in which an action relating to a data object which contains data is triggerable as a result of the performance of a drag&drop operation in the software application, wherein in the course of the operation, upon initiation of the loading of a selected source data object containing data into the software application, compatibility of the data in the source data object and at least one of the data supported by the software application and data in at least one data object already existing in the software application are used as a basis for triggering an action relating to at least one of the source data object and to the existing data object.

11. The data processing device as claimed in claim 10, wherein the source data object is loaded into the software application only if the data in the source data object and the data in a data object existing in the software application are compatible with one another.

12. The data processing device as claimed in claim 10, wherein the source data object replaces a data object existing in the software application if the data in the source data object and the data in the data object, which exists in the software application and is to be replaced, are compatible with one another.

13. The data processing device as claimed in claim 10, wherein loading the source data object into the software application involves all the data objects which exist in the software application being unloaded from the software application if the data in the source data object and the data in the existing data object(s) are not compatible with one another.

14. The data processing device as claimed in claim 10, wherein the software application includes a subarea containing only data objects containing data which are compatible with one another, the source data object being loaded into the subarea of the software application only if the data in the source data object and the data in a data object existing in the subarea are compatible with one another.

15. The data processing device as claimed in claim 10, wherein the software application includes a subarea containing only data objects containing data which are compatible with one another, the source data object, upon being loaded into the subarea, being able to replace a data object existing in the subarea of the software application if the source data object and the data in the data object existing in the subarea are compatible with one another.

16. The data processing device as claimed in claim 10, wherein the software application includes a subarea containing only data objects containing data which are compatible with one another, the loading of the source data object into the subarea involving all the data objects which exist in the subarea of the software application being unloaded if the data in the source data object and the data in the data object(s) existing in the subarea are not compatible with one another.

17. The data processing device as claimed in claim 10, wherein triggering of the action needs to be confirmed.

18. The data processing device as claimed in claim 10, wherein the data objects contain medical measured data.

19. The method as claimed in claim 1, further comprising:
triggering the action.

20. The method as claimed in claim 2, wherein the source data object replaces a data object existing in the software application if the data in the source data object and the data in the data object, which exists in the software application and is to be replaced, are compatible with one another.

21. The data processing device as claimed in claim 10, wherein the application triggers the action.

22. The data processing device as claimed in claim 11, wherein the source data object replaces a data object existing in the software application if the data in the source data object and the data in the data object, which exists in the software application and is to be replaced, are compatible with one another.

23. A computer program, when run on a computing device, adapted to perform the method of claim 1.

24. A computer program, when run on computing device, adapted to perform the method of claim 19.

25. A computer, adapted to run the computer program of claim 23.

26. A computer, adapted to run the computer program of claim 24.

27. A medical instrument comprising the computing device for running the program of claim 23.

27. A medical instrument comprising the computing device for running the program of claim 24.
